(19) United States
(12) Patent Application Publication
(10) Pub. No.: US 2009/0311073 A1
(43) Pub. Date: Dec. 17, 2009

(54) RESILIENT FLAT WASHER AND A HINGE WITH RESILIENT FLAT WASHERS

(75) Inventor: Chung-Yu Lee, Shulin City (TW)

Correspondence Address: PAI PATENT & TRADEMARK LAW FIRM, 1001 FOURTH AVENUE, SUITE 3200, SEATTLE, WA, 98154, US

(73) Assignee: SHIN ZU SHING CO., LTD., Shulin City (TW)

(21) Appl. No.: 12/137,538

(22) Filed: Jun. 12, 2008

(51) Int. Cl. F16B 39/04; E05D 11/10

(52) U.S. Cl. 411/209; 16/319

(57) ABSTRACT

A resilient flat washer has a ring and a keyed wing. The ring has an inner annular edge, an outer annular edge and at least one inner abrasion flange. The at least one inner abrasion flange is formed longitudinally on the inner annular flange. The keyed wing is formed transversely on the outer annular edge. A hinge has a stationary leaf, multiple resilient flat washers and a pintle. The resilient flat washers are mounted in a sleeve of the stationary leaf. The pintle is mounted rotatably in the rings and has a pivoting rod. The pivoting rod abuts the at least one inner abrasion flange, so the contact area between each resilient flat washer and the pivoting rod are increased. Therefore, the friction provided by the resilient flat washers is enhanced.

### BACKGROUND OF THE INVENTION

1. Field of the Invention

The present invention relates to a resilient flat washer, especially to a resilient flat washer that is used in a hinge to provide friction.

2. Description of the Prior Arts

Many appliances and electronic devices have a base and a cover, for example notebook computers. A hinge is usually mounted between the base and the cover and pivots to open or close the cover. The conventional hinge has a stationary leaf, multiple conventional resilient flat washers and a pintle. The stationary leaf is attached securely to the base and has a sleeve. The conventional resilient flat washers are mounted securely in the sleeve. The pintle is mounted through the resilient flat washers and is attached securely to the cover. When the cover is pivoted to the base, the pintle is rotated relative to and rubs against the conventional resilient flat washers to provide friction to hold the cover at any desired angle.

However, because the conventional resilient flat washers are thin, a contact area between each conventional resilient flat washer and the pintle is small. To provide sufficient friction, the conventional hinge needs to have a large number of conventional resilient flat washers. Therefore, the material cost is increased.

To overcome the shortcomings, the present invention provides a resilient flat washer and a hinge with resilient flat washers to mitigate or obviate the aforementioned problems.

### SUMMARY OF THE INVENTION

The main objective of the present invention is to provide a resilient flat washer with enhanced friction for the hinge. The resilient flat washer has a ring and a keyed wing. The ring has an inner annular edge, an outer annular edge and at least one inner abrasion flange. The at least one inner abrasion flange is formed longitudinally on the inner annular flange. The keyed wing is formed transversely on the outer annular edge. A hinge has a stationary leaf, multiple resilient flat washers and a pintle. The resilient flat washers are mounted in a sleeve of the stationary leaf. The pintle is mounted rotatably in the rings and has a pivoting rod. The pivoting rod abuts the at least one inner abrasion flange, so contact areas between each resilient flat washer and the pivoting rod are increased. Therefore, the friction provided by the resilient flat washers is enhanced.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a resilient flat washer in accordance with the present invention;

FIG. 2 is a perspective view of a second embodiment of a resilient flat washer in accordance with the present invention;

FIG. 3 is a perspective view of a third embodiment of a resilient flat washer in accordance with the present invention;

FIG. 4 is a perspective view of a fourth embodiment of a resilient flat washer in accordance with the present invention;

FIG. 5 is a perspective view of a fifth embodiment of a resilient flat washer in accordance with the present invention;

FIG. 6 is a perspective view of a sixth embodiment of a resilient flat washer in accordance with the present invention; and

FIG. 7 is an exploded perspective view of a hinge in accordance with the present invention.

### DETAILED DESCRIPTION OF THE PREFERRED EMBODIMENTS

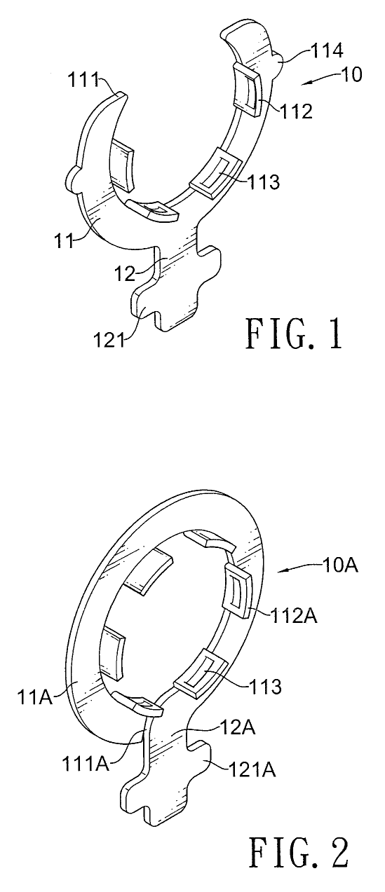

With reference to FIG. 1, a resilient flat washer (10) in accordance with the present invention comprises a ring (11) and a keyed wing (12).

The ring (11) has a first surface, an inner annular edge, an outer annular edge, a gap (111) and at least one inner abrasion flange (112).

The gap (111) is formed through the inner and outer annular edges.

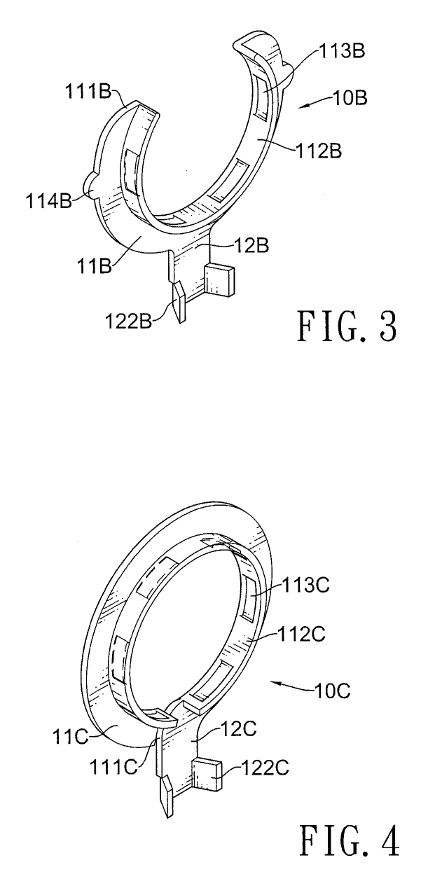

The at least one abrasion flange (112) is formed longitudinally on the inner annular edge of the ring (11) away from the first surface. In preferred embodiments as shown in FIGS. 1 and 2, the ring (11, 11A) may have multiple abrasion flanges (112, 112A) being formed separately on the inner annular edge of the ring (11, 11A). In another preferred embodiments as shown in FIGS. 3 to 6, the ring (11B, 11C, 11D, 11E) may have one abrasion flange (112B, 112C, 112D, 112E) being formed annularly on the inner annular edge of the ring (11B, 11C, 11D, 11E). Each abrasion flange (112, 112A, 112B, 112C, 112D, 112E) has at least one lubricant groove (113, 113A, 113B, 113C, 113D, 113E) being formed in an inner surface of the abrasion flange (112, 112A, 112B, 112C, 112D, 112E).

With reference to FIGS. 1 and 4, the ring (11, 11B) may have two tightening knobs (114). The tightening knobs (114, 114B) are oppositely formed transversely on the outer annular edge of the ring (11, 11B).

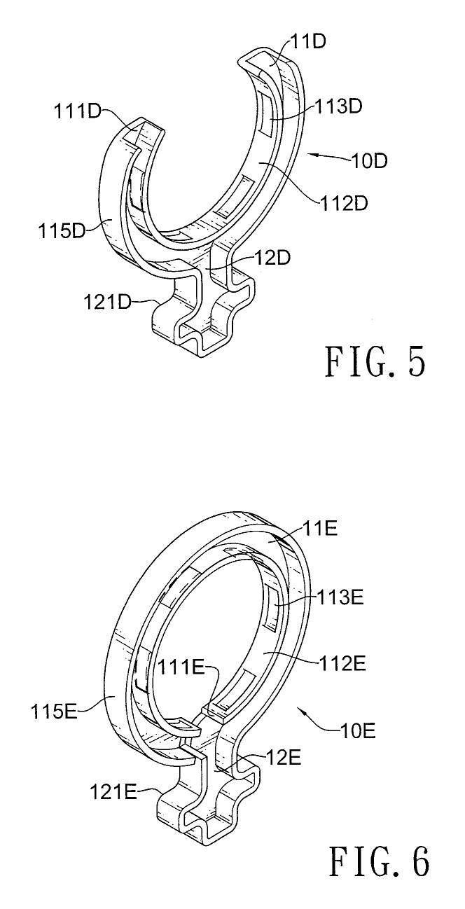

With reference to FIGS. 5 and 6, the ring (11D, 11E) may have an outer abutting protrusion (115D, 115E). The outer abutting protrusion (115D, 115E) is annularly formed longitudinally on the outer annular edge of the ring (11D, 11E) away from the first surface and corresponds to the inner abrasion flange (112D, 112E).

With reference to FIG. 1, the keyed wing (12) is formed on and protrudes transversely from the outer annular edge of the ring (11). In preferred embodiments as shown in FIGS. 1, 3 and 5, the keyed wing (12, 12B, 12D) is opposite to the gap (111, 111B, 111D) of the ring (11, 11B, 11D). In other preferred embodiments as shown in FIGS. 2, 4 and 6, the keyed wing (12A, 12C, 12E) is adjacent to the gap (111A, 111C, 111E) of the ring (11A, 11C, 11E).

With reference to FIG. 1, the keyed wing (12) has a first surface and two sides. The first surface of the keyed wing (12) corresponds to the first surface of the ring (11).

With reference to FIGS. 1, 2, 5 and 6, the keyed wing (12, 12A, 12D, 12E) may have two keyed protrusions (121, 121A, 121D, 121E). The keyed protrusions (121, 121A, 121D, 121E) are respectively formed perpendicularly on the sides of the keyed wing (12, 12A, 12D, 12E).

With reference to FIGS. 3 and 4, the keyed wing (12B, 12C) may have two tightening protrusions (122B, 122C). The tightening protrusions (122B, 122C) are formed respectively on the sides of the keyed wing (12B, 12C) protruding angularly away from the first surface of the keyed wing (12B, 12C).

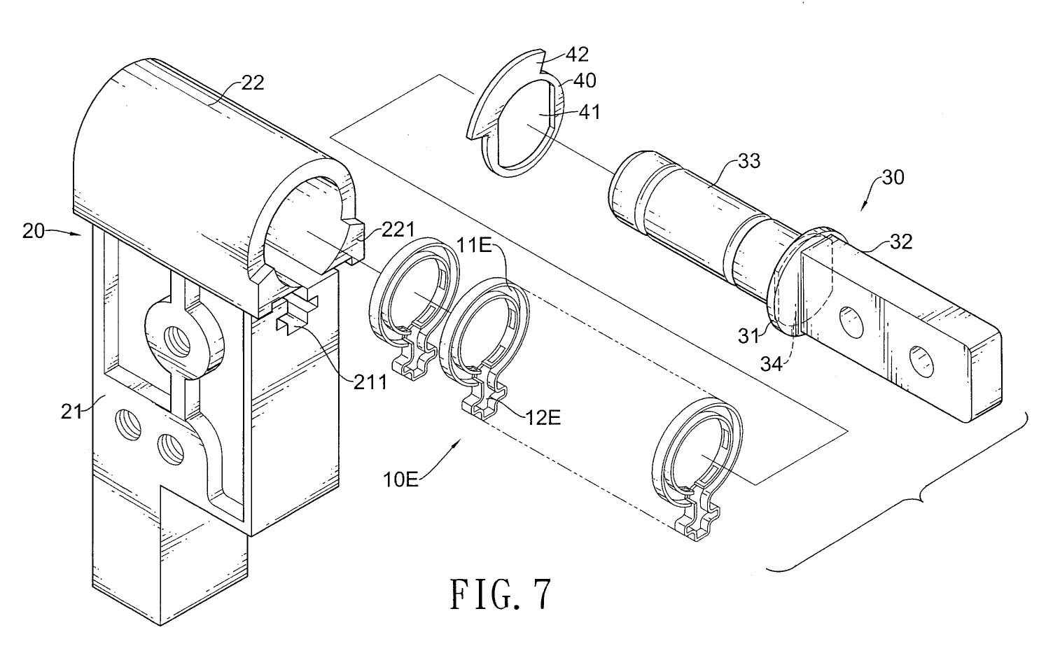

With further reference to FIG. 7, a hinge in accordance with the present invention comprises a stationary leaf (20), multiple resilient flat washers (10) as described, a pintle (30) and a limiting spacer (40).

The stationary leaf (20) has a body (21) and a sleeve (22). The body (21) has a side and an elongated keyway (211). The elongated keyway (211) is formed longitudinally in the side of the body (21), has an inside wall and may be a cross in cross section. The sleeve (22) is formed on the side of the body (21), communicates with the elongated keyway (211) and has an inside wall and two limiting stops (221). The limiting stops (221) are formed on and protrude out of opposite sides of the sleeve (22).

The resilient flat washers (10) may be selected from any of the previously described embodiments but one embodiment is shown here for clarity, but is in no way meant to be limiting. The resilient flat washers (10E) are mounted in the sleeve (22) and are mounted securely in the body (21). The rings (11E) are mounted in the sleeve (22). The keyed wings (12E) are mounted securely in the keyway (211) of the body (21).

With further reference to FIGS. 1 and 3, the tightening knobs (114, 114B) of the rings (11, 11B) abut the inside wall of the sleeve (22) to keep the rings (11, 11B) from shaking in the sleeve (22).

With further reference to FIGS. 5 and 6, the outer abutting protrusions 115D, 115E) of the rings (11D, 11E) abut the inside wall of the sleeve (22) to keep the rings (11D, 11E) from shaking in the sleeve (22).

With further reference to FIGS. 1, 2, 5 and 6, the keyed protrusions (121, 121A, 121D, 121E) of the keyed wings (12, 12A, 12D, 12E) engage the cross keyway (211) of the body (21) to mount the keyed wings (12, 12A, 12D, 12E) securely in the keyway (211).

With further reference to FIGS. 3 and 4, the tightening protrusions (122B, 122C) of the keyed wings (12B, 12C) abut the inside wall of the keyway (211) of the body (21) to mount the keyed wings (12B, 12C) securely in the keyway (211).

With reference to FIG. 7, the pintle (30) is mounted rotatably in the rings (11E) and may have an enlarged head (31), a securing rod (32), a pivoting rod (33) and a fastening protrusion (34). The enlarged head (31) has an outside surface and an inside surface. The securing rod (32) is formed on the outside surface of the enlarged head (31). The pivoting rod (33) is formed axially on and protrudes out from the inside surface of the enlarged head (31), is mounted rotatably through the rings (l E) of the resilient flat washers (10E) and abuts the inner abrasion flanges (112E) of the rings (11E). The fastening protrusion (34) is keyed, corresponds to the limiting stops (221) on the sleeve (22) and is formed between the inside surface of the enlarged head (31) and the pivoting rod (33).

The limiting spacer (40) is mounted securely on the pivoting rod of the pintle (30) and has a keyhole (41), an edge and a limiting protrusion (42). The keyhole (41) corresponds to and engages the fastening protrusion (34) of the pintle (30) to mount the limiting spacer (40) securely on the pintle (30). The limiting protrusion (42) is formed transversely on the edge of the limiting spacer (40) and selectively abuts the limiting stops (221) on the sleeve (22) to limit rotation of the pintle (30).

The advantage of the present invention is to provide the resilient flat washers (10) with enhanced friction for the hinge. When the pintle (30) is rotated in the rings (11) of the resilient flat washers (10), the pivoting rod (33) rubs against the rings (11). Because each resilient flat washer (10) has at least one inner abrasion flanges (112), the contact area between each resilient flat washer (10) and the pivoting rod (33) are increased. Therefore, the friction provided by the resilient flat washers (10) is enhanced.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A resilient flat washer comprising:
a ring having
a first surface;
an inner annular edge;
an outer annular edge;
a gap being formed through the inner and outer annular edges; and
at least one inner abrasion flange being formed longitudinally on the inner annular edge of the ring away from the first surface; and
a keyed wing being formed on and protruding transversely from the outer annular edge of the ring and having
a first surface corresponding to the first surface of the ring; and
two sides.

2. The resilient flat washer as claimed in claim 1, wherein the ring has multiple abrasion flanges being formed separately on the inner annular edge of the ring.

3. The resilient flat washer as claimed in claim 2, wherein the ring has two tightening knobs being oppositely formed transversely on the outer annular edge of the ring.

4. The resilient flat washer as claimed in claim 3, wherein the keyed wing is opposite to the gap of the ring.

5. The resilient flat washer as claimed in claim 4, wherein the keyed wing has two keyed protrusions being respectively formed perpendicularly on the sides of the keyed wing.

6. The resilient flat washer as claimed in claim 2, wherein the keyed wing is adjacent to the gap of the ring.

7. The resilient flat washer as claimed in claim 6, wherein the keyed wing has two keyed protrusions being respectively formed perpendicularly on the sides of the keyed wing.

8. The resilient flat washer as claimed in claim 1, wherein the ring has one abrasion flange being formed annularly on the inner annular edge of the ring.

9. The resilient flat washer as claimed in claim 8, wherein the ring has two tightening knobs being oppositely formed transversely on the outer annular edge of the ring.

10. The resilient flat washer as claimed in claim 9, wherein the keyed wing is opposite to the gap of the ring.

11. The resilient flat washer as claimed in claim 10, wherein the keyed wing has two tightening protrusions being formed respectively on the sides of the keyed wing away from the first surface of the keyed wing.

12. The resilient flat washer as claimed in claim 8, wherein the keyed wing is adjacent to the gap of the ring.

13. The resilient flat washer as claimed in claim 12, wherein the keyed wing has two tightening protrusions being formed respectively on the sides of the keyed wing angled away from the first surface of the keyed wing.

14. The resilient flat washer as claimed in claim 8, wherein the ring has an outer abutting protrusion being annularly formed longitudinally on the outer annular edge of the ring away from the first surface and corresponds to the inner abrasion flange.

15. The resilient flat washer as claimed in claim 14, wherein the keyed wing is opposite to the gap of the ring.

16. The resilient flat washer as claimed in claim 15, wherein the keyed wing has two keyed protrusions being respectively formed perpendicularly on the sides of the keyed wing.

17. The resilient flat washer as claimed in claim 14, wherein the keyed wing is adjacent to the gap of the ring.

18. The resilient flat washer as claimed in claim 17, wherein the keyed wing has two keyed protrusions being respectively formed perpendicularly on the sides of the keyed wing.

19. The resilient flat washer as claimed in claim 1, wherein each one of the at least one inner abrasion flange of the ring has at least one lubricant groove being formed in an inner surface of the abrasion flange.

20. A hinge comprising:
a stationary leaf having
a body having
a side; and
an elongated keyway being formed longitudinally in the side of the body; and
a sleeve being formed on the side of the body, communicating with the elongated keyway;
multiple resilient flat washers as claimed in claim 1 being mounted in the sleeve and being mounted securely in the body;
the rings of the resilient flat washers are mounted in the sleeve of the body;
the keyed wings of the resilient flat washers are mounted securely in the keyway of the body; and
a pintle being mounted rotatably in the rings of the resilient flat washers and having
an enlarged head having an outside surface and an inside surface;
a securing rod being formed on the outside surface of the enlarged head; and
a pivoting rod being formed axially on and protruding out from the inside surface of the enlarged head, being mounted rotatably into the rings of the resilient flat washers and abutting the inner abrasion flanges of the rings.
